(19) United States
(12) Patent Application Publication
(10) Pub. No.: US 2012/0216122 A1
(43) Pub. Date: Aug. 23, 2012

(54) APPLICATION STORE TOPICS

(75) Inventors: Karen K. Wong, Seattle, WA (US); Ankur Patel, Sammamish, WA (US); SweeChee Pang, Sammamish, WA (US)

(73) Assignee: MICROSOFT CORPORATION, Redmond, WA (US)

(21) Appl. No.: 13/032,803

(22) Filed: Feb. 23, 2011

(51) Int. Cl. G06F 3/01; G06F 15/16

(52) U.S. Cl. 715/738

(57) ABSTRACT

Techniques for application store topics are described that enable collaboration on application store content between a service provider and third-party collaborators. A framework of topics can be defined to include a plurality of topics to organize application data within pages for interaction with an application catalog. Collaborators can opt to submit content for one or more of the topics that are defined as customizable. The submitted content from collaborators can be incorporated into the topics and/or can replace default content provided for the topic. Different topics within the application store pages can be configured as separate and independent topic containers that can derive content from different sources. In at least some embodiments, content provided for a particular topic container within a page is selected based upon a particular type of device that navigates to the page and/or various device criteria associated with the device.

### BACKGROUND

The amount of application content available to users of various computing devices including tablet devices, laptops, mobile phones, desktop computers, and so forth, is ever-increasing. However, the sheer quantity of application choices available to users can make it difficult for users to find applications that are relevant and interesting. Due to the vast amount of application content, developers can find it difficult to describe, categorize, and promote their applications in a manner that enables users to discover their applications. Users with a limited amount of time simply may not wish to spend a great deal of time searching among a multitude of applications and therefore simply may not discover some of the “best” applications for their devices, which detracts from the overall user experiences and limits opportunities for application developers. Some application stores employ third party recommendations for applications and lists of popular applications to assist users in finding relevant applications. However, limited tools are available for developers to make their applications standout to users among the vast quantity of application choices.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Techniques for application store topics are described that enable collaboration on application store content between a service provider and third-party collaborators. A framework of topics can be defined to include a plurality of topics to organize application data within pages for interaction with an application catalog. Collaborators can opt to submit content for one or more of the topics that are defined as customizable. The submitted content from collaborators can be incorporated into the topics and/or can replace default content provided for the topic. Different topics within the application store pages can be configured as separate and independent topic containers that can derive content from different sources. In at least some embodiments, content provided for a particular topic container within a page is selected based upon a particular type of device that navigates to the page and/or various device criteria associated with the device.

### BRIEF DESCRIPTION OF THE DRAWINGS

The same numbers are used throughout the drawings to reference like features.

FIG. 1 illustrates an operating environment in which various principles described herein can be employed in accordance with one or more embodiments.

FIG. 2 is a flow diagram that describes steps of a method in accordance with one or more embodiments.

FIG. 3 is a flow diagram that describes steps of a method in accordance with one or more embodiments.

FIG. 4 is an example user interface in accordance with one or more embodiments.

FIG. 5 illustrates an example computing system that can be used to implement one or more embodiments.

### DETAILED DESCRIPTION

### Overview

Techniques for application store topics are described that enable collaboration on application store content between a service provider and third-party collaborators. A framework of topics can be defined to include a plurality of topics to organize application data within pages for interaction with an application catalog. Collaborators can opt to submit content for one or more of the topics that are defined as customizable. The submitted content from collaborators can be incorporated into the topics and/or can replace default content provided for the topic. Different topics within the application store pages can be configured as separate and independent topic containers that can derive content from different sources. In at least some embodiments, content provided for a particular topic container within a page is selected based upon a particular type of device that navigates to the page and/or various device criteria associated with the device.

In the discussion that follows, a section titled “Operating Environment” is provided and describes one environment in which one or more embodiments can be employed. Following this, a section titled “Topics Framework” describes an example framework and techniques for application store topics in accordance with one or more embodiments. Next, a section titled “Application Store Topics Implementation Details” describes example details and user interfaces in accordance with one or more embodiments. Last, a section titled “Example System” describes example computing systems and devices that can be utilized to implement one or more embodiments.

### Operating Environment

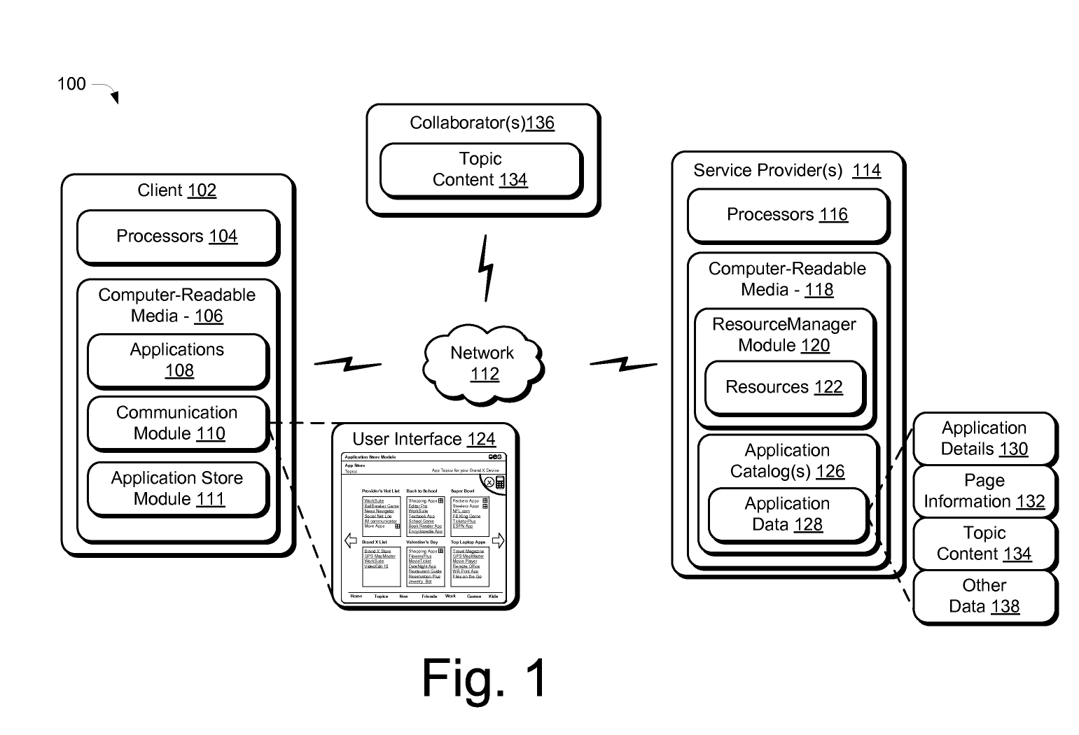

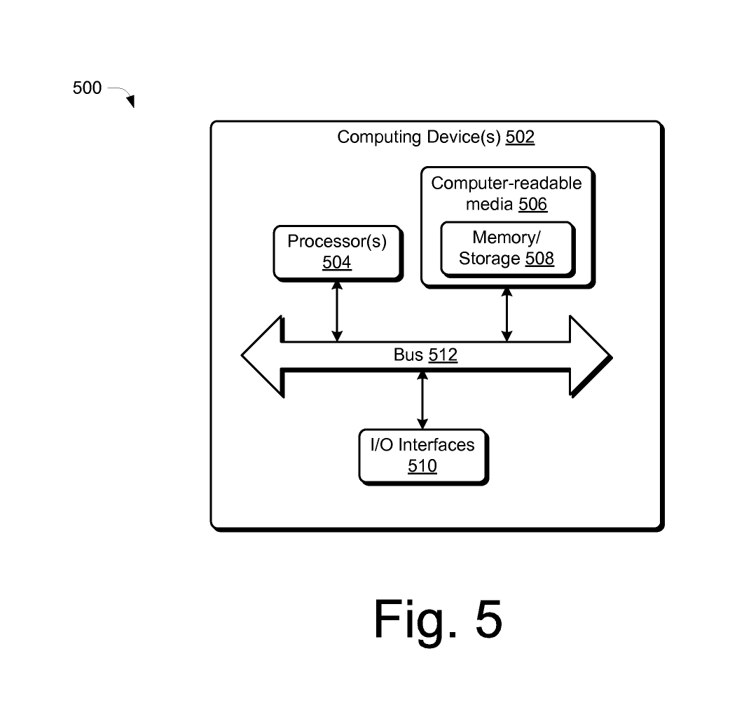

FIG. 1 illustrates an operating environment in accordance with one or more embodiments, generally at 100. Environment 100 includes a client 102 having one or more processors 104, one or more computer-readable media 106 and one or more applications 108 that reside on the computer-readable media and which are executable by the processor(s). The client 102 can be embodied as any suitable computing system and/or device such as, by way of example and not limitation, a desktop computer, a portable computer, as tablet computer, a handheld computer such as a personal digital assistant (PDA), a cell phone, a set-top box, and the like. One example of a computing system that can represent various systems and/or devices including the client 102 is shown and described below in FIG. 5.

The computer-readable media can include, by way of example and not limitation, all forms of volatile and non-volatile memory and/or storage media that are typically associated with a computing device. Such media can include ROM, RAM, flash memory, hard disk, removable media and the like. Computer-readable media can include both “computer-readable storage media” and “communication media,” examples of which can be found in the discussion of the example computing system of FIG. 5.

In addition, client 102 includes a software application in the form of a communication module 110. The communication module 110 represents functionality of the client 102 operable to communicate with and interact with various other entities (e.g., other clients, providers, servers, web sites). For example, the communication module 110 may be configured as a web browser. Interactions with other entities can include sending and receiving electronic messages in various forms (e.g., e-mail, instant messages, text messages, and so forth) between the entities, obtaining resources (e.g., content and services) from the other entities, accessing and/or downloading various applications 108 from an online application catalog or store, and so forth.

The client 102 can also include an application store module 111 that represents functionality for enabling access of the clients to an online application database, catalog, or store (e.g., an application marketplace) through which various applications 108 can be made available to clients. Application store module 111 can be implemented in various ways to facilitate access to and navigation of a database of applications 108, selection and/or purchase of applications, and download of applications to the client 102. Application store module 111 can further be configured to implement aspects of techniques for application store topics described above and below.

The application store module 111 can be implemented as a standalone client application and/or as a component of the communication module 110, such as being implemented as an add-in for a web browser. The application store module 111 can also be implemented as a web-hosted application that the client 102 can access and run in conjunction with a service provider over a network (e.g., “in the cloud”). Thus, the application store module 111 can be implemented in different ways for different client devices that can have different configurations and capabilities.

For instance, the client 102 can be communicatively coupled over a network 112, such as the Internet, with one or more service providers 114 from and to which resources (e.g., content and services) can be received and sent. Example service providers 114 of FIG. 1 are each depicted as having one or more processors 116 and one or more computer-readable media 118. A service provider 114 can be implemented by way of one or more server devices. Accordingly, various example components represented and described for a service provider 114 can be included on a single server device and/or can be divided between multiple different server devices.

Service provider 114 is depicted as including a resource manager module 120. The resource manager module 120 represents functionality operable by the service provider 114 to manage various resources 122 that may be made available over the network 112. For example, various resources 122 can be provided by way of web pages, HTML pages, application UIs, or other user interfaces 124 that are communicated over the network 112 for output by the client 102. The resource manager module 120 can manage access to the resources 122, performance of the resources 122, configuration of user interfaces or data to provide the resources 122, and so on.

Generally, resources 122 made accessible by a service provider 114 can include one or more services and/or content. A service provider 114 can provide one or more web servers and/or sites, which a client 102 can navigate to in order to access the resources 122. The resources 122 can include any suitable combination of services and/or content typically made available over a network by one or more providers. Some examples of services include, but are not limited to, an application store service to manage and provide client access to a database of applications 108, a search service, an email service to send and receive email, an instant messaging service to provide instant messages between clients 102, and a social networking service to facilitate connections and interactions between groups of users who share common interests and activities. Additional examples of services include a shopping service, a weblog service, productivity service, an authentication service, a news service, and an advertisement service to name a few. Content may include various combinations of text, video, ads, audio, multi-media streams, animations, images, web pages, web applications, device applications, content for display by a browser or other device application, pages, URLS, and/or links for use by an application store module 111, and the like.

In addition, the service provider 114 can include or otherwise make use of one or more application catalogs 126 configured to store a variety of different application data 128 related to applications that are made available to clients 102 for purchase and/or download. A variety of application data 128 can be collected from different content providers over the network 112. The content providers represent developers, device manufacturers, and other third parties who may develop applications and distribute the applications to clients using the application store infrastructure managed by the service provider 114 and represented by the example environment 100 depicted in FIG. 1.

As depicted in FIG. 1, application data 128 describing applications can include various data such as application details 130, page information 132, and topic data 134. Application details 130 can include detailed information describing applications in the applications catalog such as identifiers, pricing info, category data, developer information, ratings, descriptions, promotions, download URLs or addresses, and so forth. The applications for download can also be maintained as part of application details 130. Alternatively or in addition, download URLs or addresses can be used to access applications from various locations such as through download servers managed by the service provider 114, from different content providers, using a peer-to-peer network of clients 102, and/or using any other suitable download mechanism.

Page information 132 represents various content that can be used to build and/or output various pages for interaction with the application catalog. Page information 132 can include complete pages, portions of pages, HTML code or other mark-up language code, script, URLs and links, images, and/or other data typically used to build pages. When a client navigates through the application catalog 126 via the application store module 111, page information 132 sufficient to enable the client to render pages for interaction with the application catalog can be communicated over the network 112. This can include communicating pages that are built on the server side and/or information to enable the client 102 to build the pages on the client side.

Topic content 134 represents content that can be used in various ways to organize and promote applications within different defined topics. The topics can be defined in various ways to reflect relevant and interesting groups into which application data for an application catalog can be organized. For example, the service provider 114 can provide a framework of topics that can be arranged in different topic containers within pages that are provided for interaction with the application catalog 126. Different topics within the pages can be configured as separate and independent topic containers that can include content from different sources. This framework of separate and independent topic containers enables the service provider 114 and third parties to collaborate on the content that is presented to clients via the application store module 111. The topic content 134, framework, and topic containers can be used to promote applications with topics, designate what applications appear within different topic containers, coordinate visual appearance, themes, and layouts of pages and content between multiple parties, and so forth.

Accordingly, at least some of the topic content 134 can be obtained from collaborators 136 as depicted in FIG. 1. The collaborators 136 represent entities such as content providers, device manufacturers, application developers, and other third party “partners” that can partner with the service provider 114 to manage, provide, and promote applications using the application catalog 126 in a collaborative manner. The coordination of efforts of multiple parties through the topic framework provides a cohesive and consistent application store experience that avoids fragmented, conflicting, and/or confusing presentation of information. Additional details regarding a topics framework and techniques for application store topics can be found in relation to the following figures.

A variety of other data 138 can also be provided examples of which include, application filtering data, application support data, authentication data, client accounts and account data, and so forth.

Having described an example operating environment, consider now example procedures for application store topics in accordance with one or more embodiments.

### Topics Framework

The following section provides a discussion of a topics framework that can be implemented to enable third party collaborators to coordinate with a service provider to provide content for an application store. The topics framework is described in relation to steps of an example method in accordance with one or more embodiments. In general, various methods discussed herein can be implemented in connection with any suitable hardware, software, firmware, or combination thereof.

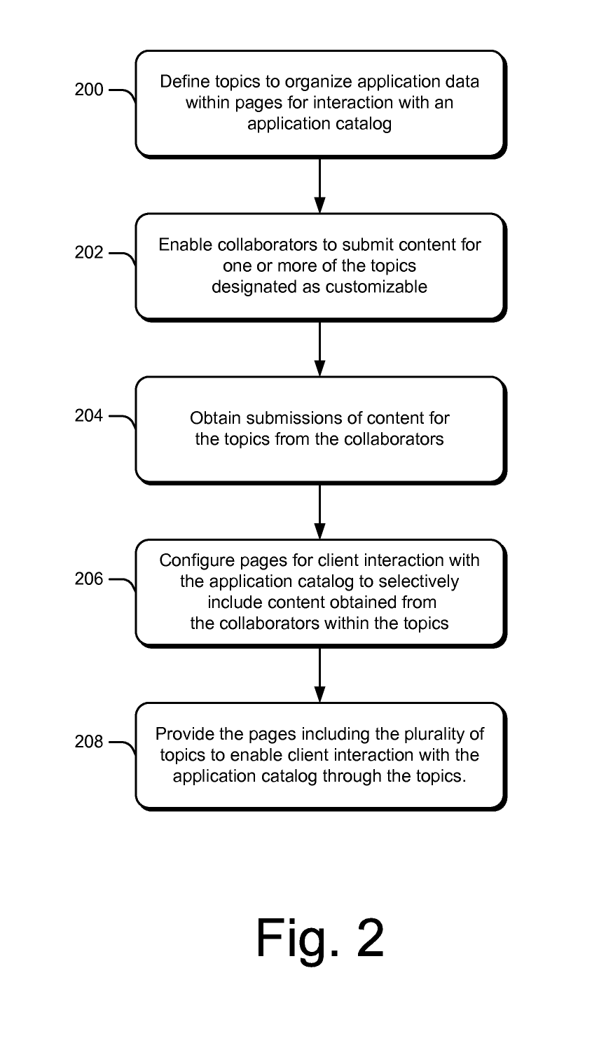

In particular, FIG. 2 depicts an example method by which collaborators are able to submit content for topics within pages used for interaction with an application catalog. In at least some embodiments, the method can be implemented by way of a suitability configured computing device, such as the example service provider 114 of FIG. 1 that includes or otherwise makes use of a resource manager module 120.

Step 200 defines topics to organize application data within pages for interaction with an application catalog. For instance, a service provider 114 can define a plurality of topics in various ways to facilitate users' interaction with an application catalog 126. As noted, various topics can be defined that generally reflect relevant and interesting groups into which application data 128 for an application catalog 126 can be organized. For example, topics can be defined to correspond to geographic locations or regions, devices and/or device types, device manufacturers or providers, a season or other time of year, current events, holidays, people, particular businesses, companies, and other entities, and so forth. Some specific examples of topics include topics for Christmas, Spring, Back-to-School, Brand X Computers, and The Super Bowl, Laptops, to name a few examples. The topics can be defined and used by collaborators in various ways and can facilitate different marketing strategies. For example, one partner can specialize in finding applications targeted to particular hardware, while another partner can specialize in finding popular applications for different age groups, and so forth. The ability to collaborate using tailored topics can therefore enable a collaborative merchandising approach that maximizes reach for multiple partners to a diverse audience of users and corresponding devices. Using the topic framework and techniques described above and below, service providers 114 and collaborators 136 can cooperate to create and publish content for inclusion within the various topics to facilitate user interaction with the application catalog 126.

Step 202 enables collaborators to submit content for one or more of the topics. The service provider 114 can enable submissions by collaborators 136 in any suitable way. Submission of content can include selecting applications to associate with topics, designing portions of pages (e.g., containers for topics) arranged to present different topics, creating promotional content for applications, and so forth. One way these submissions can occur is through a web-based interface that collaborators 136 can access over a network to view, navigate, and submit content for different topics defined by the service provider 114. The web-based interface can also include various design tools that collaborators can employ to create content for selected topics. In another approach, collaborators can develop pages or portions of pages for topics offline according to a standard topic format and/or published standards for topics defined and managed by the service provider 114. For example, the service provider 114 can provide, via the web-based interface, as an offline tool, or otherwise, a developer kit that designates topic formats and standards such as size, fonts, layout, colors, submission protocols, and so forth. Adhering to such standards and formats for submissions by collaborators ensures that pages and portions thereof from multiple sources are cohesive and have a coordinated look and feel.

In at least some embodiments, pages for interaction with the application catalog 126 can be configured to include a plurality of separate and independent containers for different topics. Different topic containers of a page can therefore be configured to obtain content and be updated from different sources. In particular, in defining the topics, the service provider 114 can designate select topics as customizable topics. The customizable topics refer to topics that collaborators 136 can generally modify to include their own content. Thus, the collaborators 136 can selectively provide submissions of content for topic containers associated with customizable topics.

In addition, the service provider 114 can designate select topics as reserved topics that are reserved for content from the service provider 114 and/or from particular collaborators 136. Reserved topics can be used to provide restricted access to certain topics. In other words, reserved topics can be associated with particular entities designated to have access to manage and/or modify the topic. Other entities can be excluded from accessing the reserved topics. Thus, one or more collaborators 136 may be restricted from modifying a reserved topic to which they have not been granted access. Pages having topic containers associated with reserved topics will display content designated by the service provider 114 and/or by corresponding collaborators 136 that have been given access to modify the particular topic.

Step 204 obtains submissions of content for the topics from the collaborators. Submissions can occur in various ways including but not limited to using the web-based interface and/or desktop tools described above. For topics that are customizable, collaborators can opt whether or not to provide content for these topics. In at least some embodiments, the service provider 114 can publish a schedule of page and/or topic updates to collaborators. The service provider 114 can then collect submissions for topics from the collaborators during a collection period. The submissions can include definitions for pages, portions of pages, topic containers, application data and lists, selections of applications for a topic, and so forth that are submitted in accordance with formats and standards controlled by the service provider 114. The service provider 114 can employ the submissions from collaborators to configure pages for the application store module 111 accordingly.

In particular, step 206 configures pages for client interaction with the application catalog to selectively include content obtained from the collaborators within the topics. For instance, the service provider 114 can configure pages based on the submissions that are obtained in step 204. Pages can be created using any suitable code language and techniques. For instance, pages can be built using various page information 132 that includes but is not limited to complete pages, page templates, portions of pages, HTML code or other mark-up language code, script, URLs and links, images, and/or other data typically used to build pages.

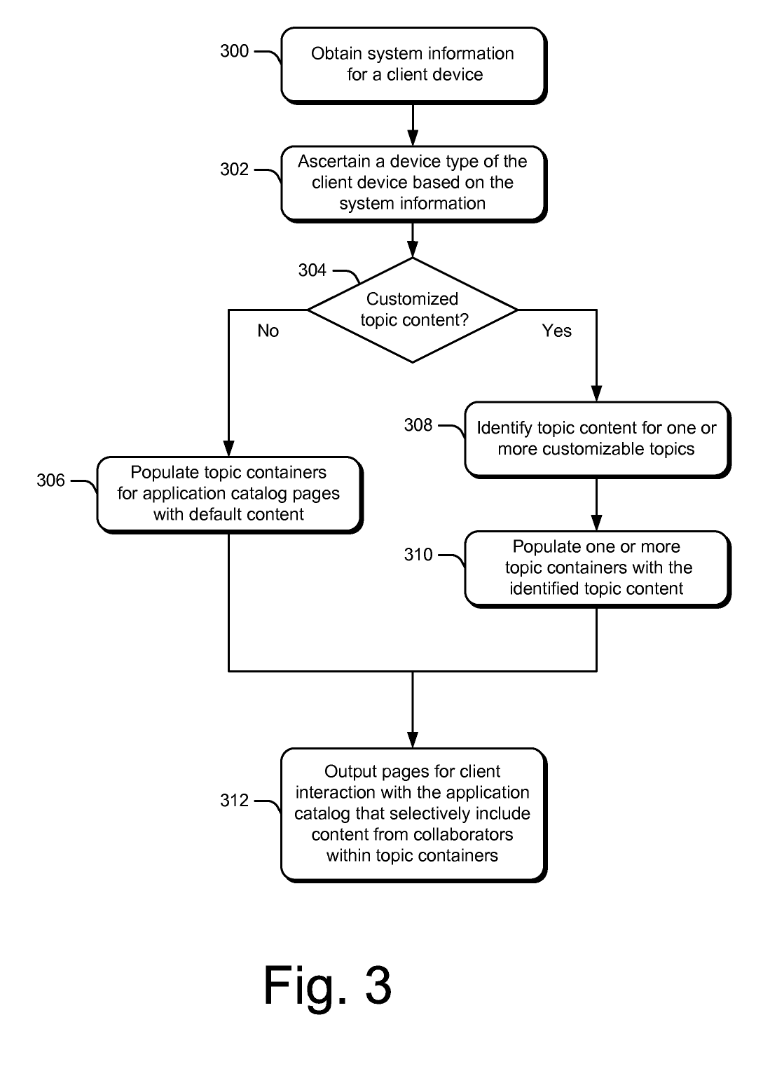

As mentioned above, pages can include various containers for topics. The service provider 114 can provide default content for the containers and configure the pages to show the default content in the absence of content from a collaborator. When a collaborator opts to provide content for a topic, the collaborator's content can be added to the default content and/or can replace the default content or a portion thereof within a corresponding container. In at least some embodiments, collaborators can be associated with particular devices and content displayed within topic containers can be dynamically changed to match a corresponding device and collaborator combination. In other words, content displayed within a particular topic container can be different depending upon the particular device accessing the application catalog 126 and/or various device criteria associated with the device. Device criteria associated with a device that can be employed to selectively show different content can include but is not limited to device type, a market segment for the device, an age group and/or other user characteristics, a level of computing expertise assigned to the device, a collaborator corresponding to the device, and so forth. Further details of selectively changing content within topic containers based upon particular devices and corresponding device criteria can be found below in relation to an example method depicted in FIG. 3.

Step 208 provides pages including the topics to enable client interaction with the application catalog through the topics. For instance, the service provider 114 can publish pages for access by clients over the network. As noted, publishing of pages can occur according to a publishing schedule that enables collaborators to submit content for the pages during a collection period. Once published, an application store module 111 can download, render, or otherwise make use of the pages to facilitate client interaction with the application catalog 126.

Thus, the topic framework just described can be implemented to enable collaboration between a service provider and one or more third-parties. In particular, pages for interaction with an application catalog can be configured to include topic containers that are separate and independent from one another. Collaborators can submit content for particular topic containers that can replace default content from the service provider. Pages can then be served to clients in various ways to enable interaction with the application catalog.

Having considered an example topics framework, consider now a discussion of example implementation details for application store topics in accordance with one or more embodiments.

### Application Store Topics Implementation Details

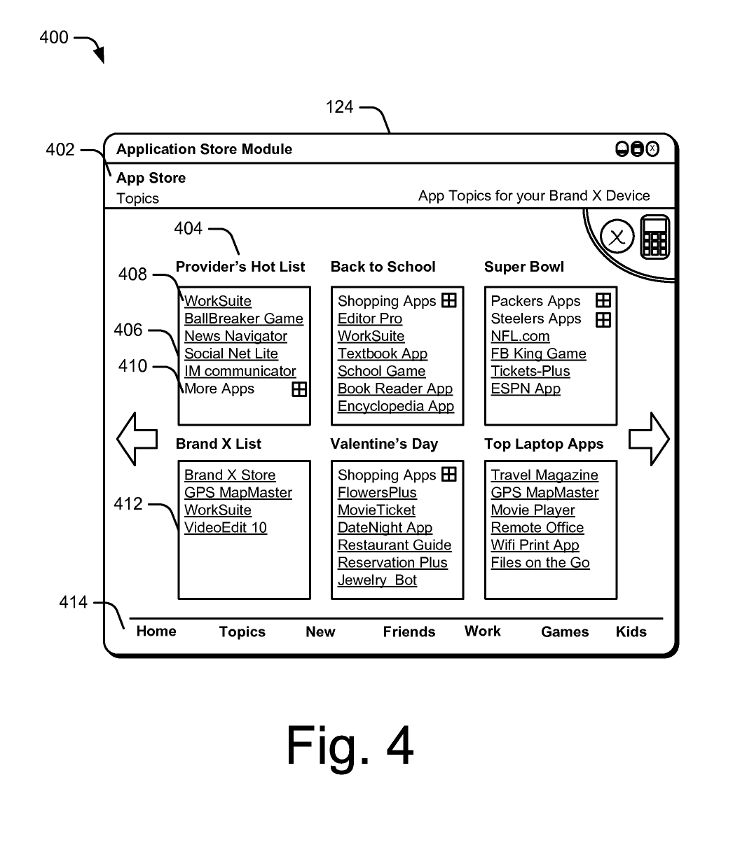

The following discussion describes implementation details regarding application store topics in accordance with one or more embodiments. The details are discussed in relation to an example method of FIG. 3 and an example user interface depicted in FIG. 4.

In particular, FIG. 3 is a flow diagram that describes steps of another method in accordance with one or more embodiments. FIG. 3 depicts details regarding selectively providing content from collaborators in various topic containers within a user interface. The example method of FIG. 3 represents but one example way in which content from collaborators can be selectively included within various topics for application store pages. In at least some embodiments, the method can be implemented by way of a suitability configured server device, such as the example service provider 114 of FIG. 1 that includes or otherwise makes use of a resource manager module 120. The method can alternatively be implemented by way of a suitability configured client device, such as the example client 102 of FIG. 1 that includes or otherwise makes use of an application store module 111. The method can also be performed by a client 102 and service provider 114 in combination.

Step 300 obtains system information for a client device. For instance, a service provider 114 can be configured to obtain system information in any suitable way. This step can occur by detecting and/or collecting system information for a client 102 that is communicated to the service provider by an application store module 111 in connection with a request to access the application catalog 126. The service provider 114 can alternatively interact with a client 102 to obtain and/or store system information at various times. In a client side implementation, the application store module 111 can collect and analyze system information locally at the client device. In some cases, this can include gathering at least some additional or supplemental information provided by the service provider 114 over the network 112.

Based on the system information, step 302 ascertains the device type and/or other device criteria associated with the client device. This can occur at the server device or at the client device. In some embodiments, the determination of the device type includes using a device class or other suitable information sufficient to ascertain criteria of the device such as the device type, manufacturer, associated collaborators, user characteristics, and other device criteria. Device classes can be defined that are configured to broadly classify devices according to device types. For example, device classes can be configured to include different classes for slate (e.g., tablet), mobile, desktop, laptop, all-in-one, and set-top box devices. Additionally or alternatively, more granular classes and/or subclasses can be defined to create classes related to different characteristics described by system information, such as indentifying the device by name, manufacturer, type of device, and so forth. Thus, the service provider and/or client can be configured to examine the device class to ascertain a variety of information regarding a particular device including at least details regarding the type of device and user of the device.

Using system information corresponding to a device, step 304 determines whether to provide customized topic content to the particular client device. This can include determining whether the client device is associated with a collaborator that opts to provide customized topic content for one or more topics. For example, the service provider 114 can make use of the device type determined in step 302 to match the device to entities such as software developers, manufacturers, content providers and/or other entities associated with the device. Alternatively or in addition, a client 102, by way of application store module 111, can be configured to determine whether the device is associated with a collaborator. Then, various targeted content can be provided by the collaborator for the device based on the device type and/or other suitable device criteria or selection criteria established by the collaborator.

The entities associated with a particular device may or may not correspond to collaborators who partner with the service provider 114 and/or provide content for the application store module 111 in connection with particular topics. Accordingly, content for inclusion within pages and/or within select topic containers can be selectively provided based in part upon whether a particular device is associated with one or more collaborators that have opted to provide customized content. Content that is provided can therefore be tailored to match particular devices based on device type and associated criteria. Further, content that is provided within the same pages and topic containers can be different for different devices.

More particularly, if the device is not associated with a collaborator that opts to provide customized topic content, step 306 populates topic containers for application catalog pages with default content. The default content can correspond to content that is provided by the service provider 114. In other words, default pages for interaction with the application catalog 111 can be provided to a device when it is determined in step 304 that there is no customized content to provide to the device.

On the other hand, if the device is associated with a collaborator that opts to provide customized topic content, step 308 identifies topic content for one or more customizable topics and step 310 populates one or more corresponding topic containers with the topic content that is identified. Thus, at least some topic containers of a page can be configured to include customized content from a collaborator corresponding to a particular client device accessing the page. The content that is selected for the device can be targeted based on various device criteria, including the example kinds of device criteria discussed previously. Different containers with the same page can even be populated with customized content from different collaborators. In other words, a page can include content from multiple different collaborators. Any other remaining containers of the page that are not populated with customized content can be populated with default content. The different separate and independent containers therefore enable page content to be derived from multiple independent sources. As long as the customized content submitted by collaborators adheres to the standards and formats established by the service provider, the resulting pages will have a cohesive look and feel.

Step 312 outputs pages for client interaction with the application catalog that selectively include content from collaborators within topic containers. For instance, pages generated by the service provider 114 can be communicated over the network 112 for output by the client 102. Alternatively or in addition, pages can be dynamically generated at the client 102 in the manner described using various page information 132 provided by the service provider 114 over the network 112. Page information 132 can include or make use of topic content 134 that is provided by one or more collaborators to describe customized content for select topics and/or topic containers. In this manner, pages for interaction with the application catalog 126 can be configured to selectively include customized content within one or more topics provided by the pages.

To further illustrate some details regarding application store topics, consider now a discussion of the example user interface that is depicted in FIG. 4. In particular, FIG. 4 depicts generally at 400 one example of a user interface 124 for interaction with an application catalog 126 that can be output via an application store module 111. In this example, the user interface 124 includes a page 402 that can include various portions that are configured to implement application store topics. The example page 402 represents a topics view of an application store that can be configured to enable navigation to various other pages. Portions in the example page as well as in other pages can be configured in various ways to present and promote application information using the notion of topics described above and below.

In particular, the page 402 includes multiple portions for topics 404 that are provided using different topic containers, an example of which is shown at 406. Each topic container 406 can be associated with one or more application portions 408 that have been organized within topics for the containers. The application portions 408 can represent applications available for purchase and/or download through the application store module 111.

Topic containers 406 can also include various instrumentalities 410 to facilitate navigation of applications and content provided for corresponding topics. For example, applications can be grouped in various groupings within a topic and instrumentalities can be provided to navigate, expand, and close the various groups. Instrumentalities 410 can also include links to different pages configured to display application details 130 for different applications, including descriptions, purchase information, download links, prices, ratings, and so forth.

Topic containers 406 can be configured in any suitable. By way of example and not limitation, the topic containers 406 in FIG. 4 are illustrated as a plurality of tiles that are associated with respective topics. In particular, FIG. 4 includes different topic containers 406 configured as generally rectilinear, e.g. rectangular tiles, for topics including “Provider's Hot List,” “Back to School,” “Super Bowl,” “Brand X List,” “Valentine's Day,” and “Top Laptops Apps.” Although, the illustrated topic containers 406 are arranged to have generally the same size and shape, the sizes and shapes of different containers can vary within the same pages and/or on different pages. For example, a page can be arranged to have one large tile for a particular topic and links to other pages with other topics. In another example, a page can be built to have a portion to display at least one relatively large topic container 406 that is provided along with one or more other portions to display relatively smaller topic containers 406. Different topics and corresponding containers can also be implemented by way of different tabs provided in the user interface 124. Although the layout and certain characteristics of topic containers 406 can vary, the service provider 114 controls the overall visual appearance, format, and themes for the topic containers 406 in the pages, so that overall the pages have a consistent visual appearance rather than appearing as a disjointed collection of content from multiple sources.

As noted, content with various topic containers 406 can be derived from different sources. The topic containers 406 are configured to be separate and independent of one another. Moreover, content appearing in one or more of the topic containers 406 can be selected to match a particular device type of a client device that accesses the application catalog and/or corresponding collaborators as described previously.

A variety of different content related to applications of the application catalog 126 can be provided using the containers. In the illustrated example, for the sake of simplicity of the drawings, the content is represented as simple lists and navigation links for application portions 408 that appear within the topic containers 406. Content provided within containers can also include images, music, promotions, audio/video presentations, dynamic and/or animated content that can be configured change over time to represent various applications, and so forth.

As mentioned previously, topics can include customizable topics and reserved topics. In FIG. 4 for example, the topic container 412 for the “Brand X List” represents a customizable topic. The content within this topic can be selected based upon the particular brand of device, which is “Brand X” in the example. If another device from “Brand Y” navigates to the same page, the content within the topic container 412 can be selected to match “Brand Y.” Thus, the customizable topic can have different content for different devices. Topics such as the “Back to School” topic and “Valentine's Day” topic also represent customizable topics for which collaborators 136 can opt to provide custom content.

The topic container 406 for the “Provider's Hot List,” on the other hand, represents a reserved topic. For instance, the “Provider's Hot List” topic can be reserved for use by a service provider 114 to include their own content, applications, promotions, and/or recommendations. The content within this topic can be designated by the service provider 114. In general, different devices that navigate to the same page are provided the same content within reserved topics. Access to modify content for a reserved topic can be limited to authorized entities that are granted such access.

A reserved topic can be associated with one or more selected collaborators. For example, the “Top Laptops Apps” topic represents a reserved topic that is associated with a particular laptop manufacturer. The laptop manufacturer can have a partner relationship with the service provider 114 and can sponsor the “Top Laptops Apps” topic. The laptop manufacturer can manage the topic and content for the topic. Other collaborators can be restricted from modifying this topic. The “Top Laptops Apps” topic can be configured to contain content designated by the laptop manufacturer in any pages in which the topic appears and across multiple different types of devices. In other words, the content appearing in the reserved topic does not depend upon the particular device that navigates to a page.

The page 402 additionally includes a navigation bar 414 that represents various navigation links that can assist a user with navigation between different pages of the application catalog. Navigation links can be configured in various ways. In the depicted example the links are configured to present different views within selected categories. For example, the “Home” link can be used to navigate to a home page for an application store. The “Topics” link can enable navigation to pages and/or views of applications organized according to different topics, such as the example page depicted in FIG. 4. As noted, the topics can be arranged to reflect different areas of interest such as geographic locations, specific devices or manufacturers, current events or holidays, and so forth. Different topic pages can present different views of applications that are relevant to various topics. The “New” link can enable navigation to a view of newly available applications. Additional example links can be provided to represent additional categories such as applications that are related to a user's friends, work applications, games, kids applications, and so forth.

Accordingly, the service provider 114 and collaborators 136 alike can employ the topic framework and notion of different topics described herein to organize and surface selected applications to users, promote selected applications, and generally to provide a mechanism that can increase the chance for applications promoted using the topics to be discovered by users. Having considered example implementation details for application store topics, consider now an example system that can be employed to implement various aspects of application store topics in accordance with one or more embodiments.

### Example System

FIG. 5 illustrates an example system generally at 500 that includes an example computing device 502 that is representative of one or more such computing systems and/or devices that may implement the various embodiments described above. The computing device 502 may be, for example, a server of a service provider 114, a device associated with the client 102 (e.g., a client device), an on-chip system, and/or any other suitable computing device or computing system.

The example computing device 502 includes one or more processors 504 or processing units, one or more computer-readable media 506 which may include one or more memory and/or storage components 508, one or more input/output (I/O) interfaces 510 for input/output (I/O) devices, and a bus 512 that allows the various components and devices to communicate one to another. Computer-readable media 506 and/or one or more I/O devices may be included as part of, or alternatively may be coupled to, the computing device 502. The bus 512 represents one or more of several types of bus structures, including a memory bus or memory controller, a peripheral bus, an accelerated graphics port, and a processor or local bus using any of a variety of bus architectures. The bus 512 may include wired and/or wireless buses.

The one or more processors 504 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions. The memory/storage component 508 represents memory/storage capacity associated with one or more computer-readable media. The memory/storage component 508 may include volatile media (such as random access memory (RAM)) and/or nonvolatile media (such as read only memory (ROM), Flash memory, optical disks, magnetic disks, and so forth). The memory/storage component 508 may include fixed media (e.g., RAM, ROM, a fixed hard drive, etc.) as well as removable media (e.g., a Flash memory drive, a removable hard drive, an optical disk, and so forth).

Input/output interface(s) 510 allow a user to enter commands and information to computing device 502, and also allow information to be presented to the user and/or other components or devices using various input/output devices. Examples of input devices include a keyboard, a cursor control device (e.g., a mouse), a microphone, a scanner, and so forth. Examples of output devices include a display device (e.g., a monitor or projector), speakers, a printer, a network card, and so forth.

Various techniques may be described herein in the general context of software, hardware (fixed logic circuitry), or program modules. Generally, such modules include routines, programs, objects, elements, components, data structures, and so forth that perform particular tasks or implement particular abstract data types. An implementation of these modules and techniques may be stored on or transmitted across some form of computer-readable media. The computer-readable media may include a variety of available medium or media that may be accessed by a computing device. By way of example, and not limitation, computer-readable media may include “computer-readable storage media” and “communication media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. Computer-readable storage media also includes hardware elements having instructions, modules, and/or fixed device logic implemented in a hardware form that may be employed in some embodiments to implement aspects of the described techniques.

The computer-readable storage media includes volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, hardware elements (e.g., fixed logic) of an integrated circuit or chip, or other storage device, tangible media, or article of manufacture suitable to store the desired information and which may be accessed by a computer.

“Communication media” may refer to a signal bearing medium that is configured to transmit instructions to the hardware of the computing device, such as via the network 112. Communication media typically may embody computer readable instructions, data structures, program modules, or other data in a modulated data signal, such as carrier waves, data signals, or other transport mechanism. Communication media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

Combinations of any of the above are also included within the scope of computer-readable media. Accordingly, software, hardware, or program modules, including the service manager module 120, applications 108, communication module 110, application store module 111 and other program modules, may be implemented as one or more instructions and/or logic embodied on some form of computer-readable media.

Accordingly, particular modules, functionality, components, and techniques described herein may be implemented in software, hardware, firmware and/or combinations thereof The computing device 502 may be configured to implement particular instructions and/or functions corresponding to the software and/or hardware modules implemented on computer-readable media. The instructions and/or functions may be executable/operable by one or more articles of manufacture (for example, one or more computing devices 502 and/or processors 504) to implement techniques for application store topics, as well as other techniques. Such techniques include, but are not limited to, the example procedures described herein. Thus, computer-readable media may be configured to store or otherwise provide instructions that, when executed by one or more devices described herein, cause various techniques for application store topics.

### Conclusion

Techniques for application store topics are described that enable collaboration on application store content between a service provider and third-party collaborators. A framework of topics can be defined to include a plurality of topics to organize application data within pages for interaction with an application catalog. Collaborators can opt to submit content for one or more of the topics that are defined as customizable. The submitted content from collaborators can be incorporated into the topics and/or can replace default content provided for the topic. Different topics within the application store pages can be configured as separate and independent topic containers that can derive content from different sources. In at least some embodiments, content provided for a particular topic container within a page is selected based upon a particular type of device that navigates to the page.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented method comprising:
defining topics to organize application data within pages for interaction with an application catalog;
enabling collaborators to submit content for one or more of the topics;
obtaining submissions of content for the one or more topics from the collaborators; and
configuring pages for interaction with the application catalog to selectively include the content obtained from the collaborators within the topics.

2. The computer-implemented method of claim 1, further comprising:
providing the pages over a network to a client to enable interaction of the client with the application catalog through the topics.

3. The computer-implemented method of claim 1, further comprising exposing a web-based interface to enable the submissions from the collaborators and obtaining the submissions through the web-based interface.

4. The computer-implemented method of claim 1, wherein configuring the pages comprises configuring the pages to dynamically select content to include in the pages based upon device criteria associated with a particular type of device that navigates to the pages.

5. The computer-implemented method of claim 1, wherein configuring the pages comprises configuring the pages to include multiple separate and independent topic containers each corresponding to a different one of the topics.

6. The computer-implemented method of claim 5, wherein the topic containers are designed to enable display of content for the application catalog obtained from multiple different sources.

7. The computer-implemented method of claim 1, wherein the topics are defined to correspond to one or more of: a geographic location, a device type, a device manufacturer, a time of year, a current event, a holiday, a person, or a business.

8. The computer-implemented method of claim 1, further comprising designating one or more of the topics as customizable topics that are made accessible to collaborators to selectively provide customized topic content for the customizable topics.

9. The computer-implemented method of claim 1, further comprising designating one or more of the topics as reserved topics to which access is restricted.

10. The computer-implemented method of claim 1, wherein configuring pages further comprises:
ascertaining a device type of a client device that navigates to the pages; and
based on the device type, determining whether to include customized topic content provided by one or more of the collaborators within one or more topics included in the pages.

11. A computer implemented method comprising:
obtaining system information for a client device;
ascertaining a device type of the client device based on the system information; and
determining, based on the device type, whether to include customized topic content provided by one or more collaborators within one or more topic containers included in pages provided by a service provider for interaction with an application catalog.

12. The computer implemented method of claim 11, wherein the topic containers are configured as separate and independent portions of the pages to selectively obtain content from multiple sources according to the ascertained device type.

13. The computer implemented method of claim 11, wherein the system information comprises a device class assigned to the client device to classify the client device according to the device type.

14. The computer implemented method of claim 11, wherein determining whether to include customized topic content comprises determining based on the device type whether the client device is associated with a collaborator that provides customized topic content for one or more of the topics.

15. The computer implemented method of claim 11, further comprising:
populating at least some of topic containers with customized topic content when, based on the device type, the client device is associated with a collaborator that provides customized topic content for one or more of the topics.

16. The computer implemented method of claim 11, further comprising:
populating the topic containers with default content from the service provider when, based on the device type, the client device is not associated with a collaborator that provides customized topic content for one or more of the topics.

17. One or more computer-readable storage media storing instructions that, when executed via one or more computing devices, implement an application store module for interaction with an application catalog from a service provider, the application store module configured to:
expose a user interface having a plurality of topic containers corresponding to different topics and implemented as separate and independent portions of the user interface to organize application data from the application catalog according to the corresponding topics;
ascertain a device type associated with a client device that accesses the application catalog; and
selectively populate the plurality of topic containers with content from the service provider and one or more collaborators based upon the device type ascertained for the client device.

18. One or more computer-readable storage media of claim 17, wherein at least one of the topic containers corresponds to a reserved topic that is reserved to display content from the service provider.

19. One or more computer-readable storage media of claim 17, wherein at least one of the topic containers corresponds to a customizable topic that is accessible to collaborators to selectively provide customized topic content for the customizable topic.

20. One or more computer-readable storage media of claim 17, wherein the topics are configured to reflect different areas of interest into which applications in the application catalog can be arranged including geographic locations, particular devices, and current events.
